(19) United States
(12) Patent Application Publication
(10) Pub. No.: US 2022/0024380 A1
(43) Pub. Date: Jan. 27, 2022

(54) VEHICLE INTERIOR LIGHTING SYSTEM WITH ACTIVATION CONTROL

(71) Applicant: Ford Global Technologies, LLC, Dearborn, MI (US)

(72) Inventors: Linsheng Chen, Novi, MI (US); Scott Holmes Dunham, Redford, MI (US)

(73) Assignee: Ford Global Technologies, LLC, Dearborn, MI (US)

(21) Appl. No.: 16/939,145

(22) Filed: Jul. 27, 2020

(51) Int. Cl. B60Q 3/82; G06K 9/00; H05B 47/13; H05B 47/11; H05B 47/125; B60Q 3/76

(52) U.S. Cl. CPC B60Q 3/82; G06K 9/00832; B60Q 3/76; H05B 47/11; H05B 47/125; H05B 47/13

(57) ABSTRACT

A vehicle lighting system is provided that includes an invisible light source generating invisible light in a region proximate to a seated passenger in the vehicle, an invisible light sensor configured to receive the invisible light reflected from one or more objects in the region, a reading lamp configured to illuminate visible light to the region proximate to the passenger seated in the vehicle, and a controller detecting a presence of reading material in the region based on the reflected invisible light, and controlling the reading lamp to activate the light source when reading material is detected in the region.

### FIELD OF THE DISCLOSURE

The present disclosure generally relates to a vehicle lighting system, and more particularly relates to automatically controlling activation of an interior reading lamp.

### BACKGROUND OF THE DISCLOSURE

Automotive vehicles are commonly equipped with various lights for illuminating the passenger compartment of the vehicle. For example, vehicles are commonly equipped with reading lamps to provide light illumination proximate to a passenger seated in the vehicle. The light illumination may enable the passenger to view reading material, such as books, maps, etc. To activate the lighting system, one or more user input switches are typically provided. It may be desirable to provide for automatic lighting control within the vehicle.

### SUMMARY OF THE DISCLOSURE

According to a first aspect of the present disclosure, a vehicle lighting system is provided.

The vehicle lighting system includes an invisible light source generating invisible light in a region proximate to a seated passenger in the vehicle, an invisible light sensor configured to sense the invisible light reflected from one or more objects in the region, a reading lamp configured to illuminate visible light to the region proximate to the seated passenger in the vehicle, and a controller detecting a presence of reading material in the region based on the reflected invisible light and controlling the reading lamp to activate the reading lamp when reading material is detected in the region.

Embodiments of the first aspect of the disclosure can include any one or a combination of the following features:
the invisible light source comprises an infrared light source;
the invisible light source generates a pattern of invisible light in a cone-shaped pattern;
a visible light photosensor for sensing ambient light, wherein the controller further controls the reading lamp when the sensed ambient light is below a predetermined light value;
a camera sensor for capturing one or more images in the region proximate to the seated passenger in the vehicle, wherein the controller further controls the reading lamp based on the captured images containing the reading material;
the controller increases or decreases light intensity from the reading lamp based on the sensed invisible light; and
the invisible light source and invisible light sensor are located proximate to a roof of the vehicle.

According to a second aspect of the present disclosure, a vehicle is provided. The vehicle includes a seat located within the vehicle body and a vehicle lighting system. The vehicle lighting system includes an invisible light source generating invisible light in a region proximate to a seated passenger in the vehicle, an invisible light sensor configured to sense the invisible light reflected from one or more objects in the region, a reading lamp configured to illuminate visible light to the region proximate to the passenger seated in the vehicle, and a controller detecting a presence of reading material in the region based on the reflected invisible light and controlling the reading lamp to activate the reading lamp when reading material is detected in the region.

Embodiments of the second aspect of the disclosure can include any one or a combination of the following features:
the invisible light source comprises an infrared light source;
the invisible light source generates a pattern of invisible light in a cone-shaped pattern;
a visible light photosensor for sensing ambient light, wherein the controller further controls the reading lamp when the sensed ambient light is below a predetermined light value;
a camera sensor for capturing one or more images in the region proximate to the seated passenger in the vehicle, wherein the controller further controls the reading lamp based on the captured images containing the reading material;
the controller increases or decreases light intensity from the reading lamp based on the sensed invisible light; and
the invisible light source and invisible light sensor are located proximate to a roof of the vehicle.

According to yet another aspect of the present disclosure, a method of controlling a reading lamp on a vehicle. The method includes the steps of illuminating a region proximate to a passenger in a vehicle with invisible light, sensing with an invisible light sensor an amplitude of the invisible light reflected from one or more objects in the region proximate to the passenger in the vehicle, determining with a controller a presence of reading material in the region based on amplitude of the reflected invisible light, and activating with the controller the reading lamp when the amplitude exceeds a predetermined value.

Embodiments of the third aspect of the disclosure can include any one or a combination of the following features:
the invisible light source comprises an infrared light source;
the invisible light source generates a pattern of invisible light in a cone-shaped pattern;
the step of sensing ambient light with a visible light photosensor, wherein the controller further controls the reading lamp based on the sensed ambient light;
the step of capturing with a camera sensor one or more images of the region proximate to the passenger in the vehicle, wherein the controller further controls the reading lamp based on the captured images containing the reading material; and
the step of adjusting light intensity of the reading lamp based on the reflected invisible light.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a side perspective view of a passenger compartment of a vehicle equipped with a vehicle lighting system, according to one embodiment;

FIG. 2 is an enlarged view of an overhead console containing the vehicle lighting system of FIG. 1;

FIG. 3 is a block diagram illustrating the vehicle lighting system with the controller, according to one embodiment; and

FIG. 4 is a flow diagram illustrating a routine for controlling the vehicle lighting system, according to one embodiment.

### DETAILED DESCRIPTION OF THE PREFERRED EMBODIMENTS

As required, detailed embodiments of the present invention are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

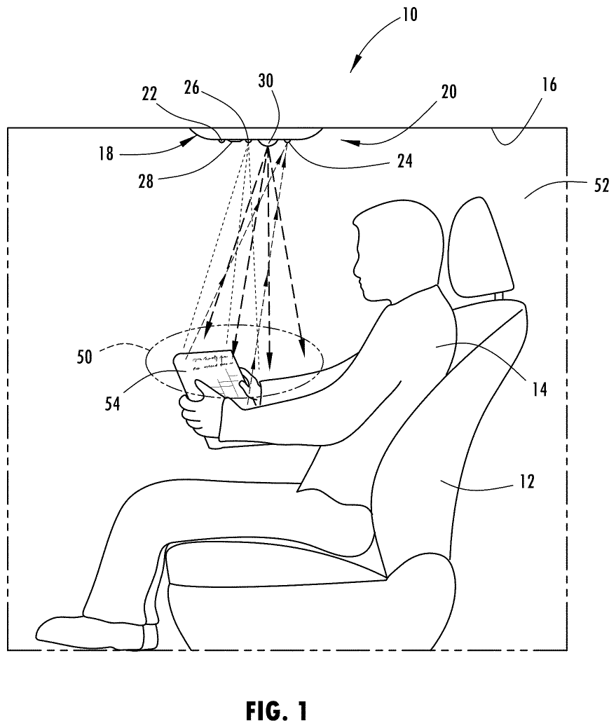

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a restraint monitoring system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, the passenger compartment 52 of an automotive vehicle 10 is generally illustrated equipped with a vehicle lighting system 20, according to one embodiment. The vehicle 10 may be a motor vehicle, for example, a wheeled motor vehicle which may include a car, truck, van, bus, SUV, etc. The passenger compartment 52 may be equipped with a seating arrangement having one or more seats 12 for seating one or more passengers 14. It should be appreciated that the vehicle 10 may include any of a number of seats 12 including a driver seat, and various passenger seats, located at one or more locations throughout the passenger compartment 52. The seating arrangement may include two or three seats within each row of seating and there may be multiple rows of seating within the passenger compartment of the vehicle 10.

The vehicle lighting system 20 is shown located in the interior of the passenger compartment above the seating arrangement proximate to the underside of the roof 16 of the vehicle body, according to one example. More specifically, the vehicle lighting system 20 is shown located in an overhead console 18 that, in turn, is assembled to an underlying surface, such as a headliner, of the roof 16. As such, the overhead console 18 is located at an elevation generally above one or more of the vehicle seats 12, and may be located centrally between a driver seat and a passenger seat.

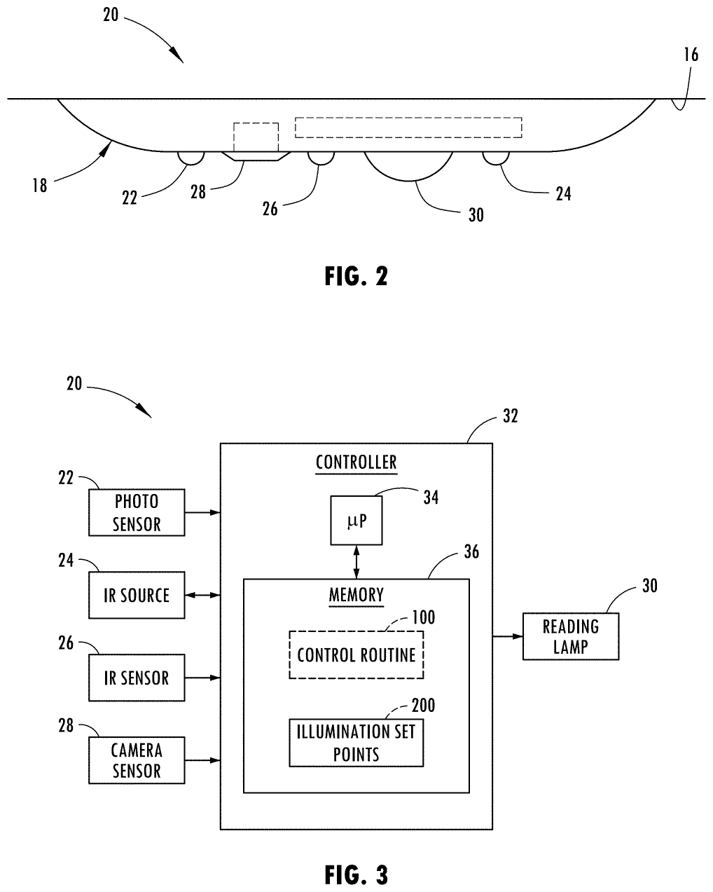

As seen in FIGS. 1 and 2, the overhead console 18 may include various features including user control inputs such as pushbutton or proximity switches for controlling various features or functions on the vehicle. The user control inputs may include manually actuatable inputs for controlling features, such as controlling lighting, moonroof and sunshade movement, and other functions. In addition, the overhead console 18 is equipped with one or more reading lamps 30. In the example shown, the overhead console 18 has one reading lamp for illuminating a region proximate to a seat. It should be appreciated that the overhead console may be equipped with multiple lighting systems 20 for illuminating multiple regions proximate to a plurality of seats such as seats in the first row of seating, namely the driver seat and a passenger seat. Each reading lamp 30 may include one or more light-emitting diodes (LEDs) as light sources generating a visible light, such as white light, in an output beam directed to a region 50 proximate to a location where reading material may be viewed by a passenger of the vehicle 10 seated on one of the seats 12. The reading lamp 30 may be activated to illuminate the region 50 to enable a passenger seated in a seat 12 to view reading material 54, such as books, maps, etc. when the ambient lighting conditions within the vehicle 10 are poor or insufficient. The reading lamp 30 may generate a cone-shaped pattern of light, according to one example.

The vehicle lighting system 20 also includes an invisible light source 24 for generating an invisible light beam that is generally invisible to human beings. The invisible light source 24 may be an infrared (IR) light source having, for example, one or more IR LEDs for illuminating a beam of infrared radiation to the region 50 proximate to a passenger seated in seat 12 where reading materials would be viewed by a passenger seated in the seat 12. The invisible light source 24 may output a cone-shaped illumination pattern and is generally invisible to a human being.

An invisible light sensor 26 is provided in the vehicle lighting system 20. The invisible light sensor 26 is oriented to sense the invisible light that is reflected from one or more objects in the region 50 proximate to a passenger 14 seated in seat 12. The invisible light sensor 26 is configured to detect the amplitude of invisible light (e.g., IR radiation) generated by the invisible light source that is reflected from one or more surfaces in the region 50. The invisible light source 24 and invisible light sensor 26 are positioned to respectively transmit invisible light and receive reflected invisible light from the region 50 where a passenger will be expected to hold a book, map, or other reading material 50. By measuring the amplitude of the reflected invisible light, a determination as to whether the object reflecting the light is a reading material 54 can be determined and used to control the reading lamp 30. This is because reading material, such as books and maps, have a substantial amount of light reflective surface, such as is the case with the medium used for white paper which will tend to reflect the invisible light at a greater amplitude as compared to other types of objects that are less reflective, such as the clothing of a passenger. By detecting a highly light reflective surface based on the detected signal amplitude, a determination as to whether the object reflecting the invisible light is a reading material can be determined and used to control the reading lamp 30. The controller may further increase or decrease light intensity output from the reading lamp based on the sensed invisible light.

The invisible light sensor 26 may be sensitive only to the invisible light wavelength, such as IR light, transmitted by the invisible light source 24. When the IR light is reflected from reading material having a highly light reflective surface, such as a white surface, the amplitude of the received reflected light may be near 100%. The irradiance on the surface of an object in the region has an illuminance E=I/d² which is referred to as the inverse square law for light intensity, where d is the target distance and I is the illuminant intensity. The intensity of light detected from a reflective reading material 54 will be generally greater than light reflected from other objects within the region such as a body part of the passenger and clothing of the passenger. By comparing the amplitude of the reflected signal to predetermined values such as illumination set points, reading material 54 can be distinguished from other objects having less light reflectance and the comparison may be used to control the light assembly.

It should be appreciated that the light sources and light sensors may each include a cone-shaped pattern to cover the region 50, according to one embodiment or may include other beam shapes. It should further be appreciated that the reading lamp 30 may employ dynamic beam shaping technology to vary the size and shape of the light output beam. The light output beams and the sensor detection may be moved to accommodate changes in the position of the seat 12. One example of a dynamic beam shaping technology may include using liquid crystal materials that may be altered with an electric field applied to a lens to change liquid crystal molecules orientation and cause light passing through the lens to be refocused.

The vehicle lighting system 20 also includes a visible light photosensor 22 for detecting ambient visible light within the vehicle 10. By sensing the ambient visible light, a determination as to whether or not the environmental lighting within the vehicle is insufficient for reading purposes, such as while experiencing darkness can be determined. When the ambient light is below a predetermined threshold, indicative of low or no lighting, the reading lamp 30 can automatically be turned on when reading material is detected in the region 50 proximate to the passenger.

A camera sensor 28 is also shown available for use with the vehicle lighting system 20. The camera sensor 28 may include an imaging camera for capturing one or more images of the region 50 proximate to the passenger in seat 12. The captured images may be processed to determine whether or not reading material is detected in the captured images and may be used as a redundancy check to confirm that one or more reading materials 54 are present, as an optional feature. Detecting the presence of reading material 54 in the region in the captured images may be performed by comparing known images of reading materials (e.g., books, maps, etc.) to the captured images.

In one embodiment, the vehicle lighting system 20 is located in an overhead console proximate to the roof of the vehicle. However, it should be appreciated that the vehicle lighting system 20 may be located elsewhere in the vehicle 10, preferably at a location where the sensors and light sources may transmit and capture light signals directed to the region 50 where reading material 54 proximate to a user for viewing by the user may be expected to be located on the vehicle 10. The various light sources and sensors may be integrated in a common package or may be separately located in the vehicle 10.

Referring to FIG. 3, the vehicle lighting system 20 is shown having a controller 32 for receiving the various inputs including the invisible light source 24, invisible light sensor 26, visible photosensor 22, and camera sensor 28. The controller 32 may include a microprocessor 34 or other control circuitry including digital and/or analog control circuitry for processing the various inputs and generating inputs to control the vehicle reading lamp 30. The controller 32 may include memory 36 which may include one or more control routines 100 that may be executed by the microprocessor 34 and may further include illumination set points 200 for determining light illumination set points. It should be appreciated that other digital and/or analog circuitry may be employed according to other embodiments.

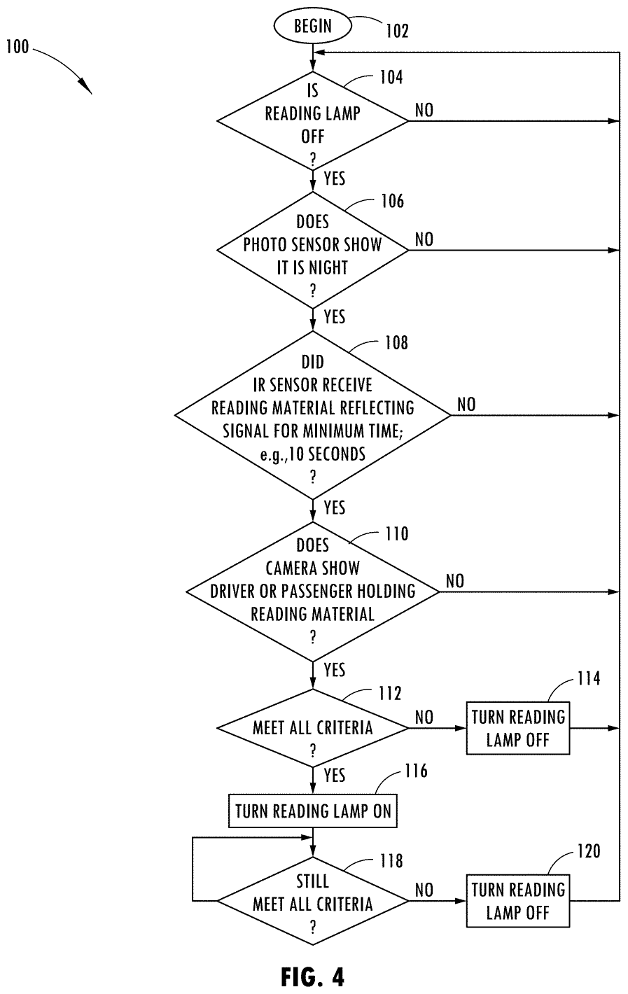

Referring to FIG. 4, a routine 100 for controlling the reading lamp 30 with the vehicle lighting system 20 is illustrated, according to one embodiment. Routine 100 begins at step 102 and proceeds to decision step 104 to determine if the reading lamp is deactivated or off and, if not, returns to the beginning of the routine 100. If the reading lamp is determined to be off, routine 100 proceeds to decision step 106 to determine if the photosensor senses the ambient lighting conditions are low light conditions or it is dark and, if not, returns to the beginning. If the photosensor senses low light conditions, routine 100 proceeds to decision step 108 to determine if the IR sensor has detected the presence of a book or map or other reading material in the region proximate to the user based on the amplitude of the reflecting invisible light signal for a minimum time period, such as 10 seconds and, if not, returns to the beginning of the routine. If the IR sensor has detected the presence of reading material in the region such as a book or map reflecting signal for the minimum time period of 10 seconds, routine 100 proceeds to decision step 110 to determine if the camera shows a driver or passenger is holding a reading material, such as a book or map and, if not, returns to the beginning of the routine 100. If the camera determines that the driver or passenger is holding a reading material, such as a book or map, routine 100 proceeds to decision 112 to determine if all of the criteria for activating or turning on the reading lamp have been met. If the criteria have not been met, routine 100 proceeds to step 114, to turn the reading lamp off, and then returns to the beginning of the routine. If all of the criteria have been met, routine 100 proceeds to step 116 to turn the reading lamp on. Next, routine 100 determines at decision step 118 if all of the criteria for turning the reading lamp on is met and, if so, continues to activate the reading lamp. If the criteria is not completely met, routine 100 proceeds to step 120 to turn the reading lamp off before returning to the beginning of the routine 100.

Accordingly, the vehicle light assembly 20 advantageously automatically controls a reading lamp in a vehicle 10 to enable a passenger to activate the reading lamp when reading material is detected present in a region proximate to a passenger. As a result, a passenger may not be required to separately activate a switch input to turn the light assembly 20 on or off

It is to be understood that variations and modifications can be made on the aforementioned structure without departing from the concepts of the present disclosure, and further it is to be understood that such concepts are intended to be covered by the following claims unless these claims by their language expressly state otherwise.

1. A vehicle lighting system comprising:
an invisible light source generating invisible light within an illumination pattern that defines a region proximate to a seated passenger in the vehicle;
an invisible light sensor configured to sense the invisible light reflected from one or more objects in the region;
a reading lamp configured to illuminate visible light to the region proximate to the seated passenger in the vehicle; and
a controller detecting and determining a presence of reading material having a substantial amount of light reflective surface in the region by comparing the reflected invisible light to one or more predetermined values indicative of reading material, and controlling the reading lamp to turn on the reading lamp automatically when reading material is detected in the region without having to activate a switch to turn on the reading lamp.

2. The vehicle lighting system of claim 1, wherein the invisible light source comprises an infrared light source.

3. The vehicle lighting system of claim 1, wherein the invisible light source generates a pattern of invisible light in a cone-shaped pattern.

4. The vehicle lighting system of claim 1 further comprising a visible light photosensor for sensing ambient light, wherein the controller further controls the reading lamp when the sensed ambient light is below a predetermined light value.

5. The vehicle lighting system of claim 1 further comprising a camera sensor for capturing one or more images in the region proximate to the seated passenger in the vehicle, wherein the controller further controls the reading lamp to turn the reading lamp on based on the captured images containing the reading material.

6. The vehicle lighting system of claim 1, wherein the controller increases or decreases light intensity from the reading lamp based on the sensed invisible light.

7. The vehicle lighting system of claim 1, wherein the invisible light source and invisible light sensor are located proximate to a roof of the vehicle.

8. A vehicle comprising:
a vehicle body;
a seat located within the vehicle body; and
a vehicle lighting system comprising:
an invisible light source generating invisible light within an illumination pattern that defines a region proximate to a seated passenger in the vehicle;
an invisible light sensor configured to sense the invisible light reflected from one or more objects in the region;
a reading lamp configured to illuminate visible light to the region proximate to the passenger seated in the vehicle; and
a controller detecting and determining a presence of reading material having a substantial amount of light reflective material in the region by comparing the reflected invisible light to one or more predetermined values indicative of ready material, and controlling the reading lamp to turn on the reading lamp automatically when reading material is detected in the region without having to activate a switch to turn on the lamp.

9. The vehicle of claim 8, wherein the invisible light source comprises an infrared light source.

10. The vehicle of claim 8, wherein the invisible light source generates a pattern of invisible light in a cone-shaped pattern.

11. The vehicle of claim 8 further comprising a visible light photosensor for sensing ambient light, wherein the controller further controls the reading lamp when the sensed ambient light is below a predetermined light value.

12. The vehicle of claim 8 further comprising a camera sensor for capturing one or more images in the region proximate to the seated passenger in the vehicle, wherein the controller further controls the reading lamp to turn on the reading lamp based on the captured images containing the reading material.

13. The vehicle of claim 8, wherein the controller increases or decreases light intensity from the reading lamp based on the sensed invisible light.

14. The vehicle of claim 8, wherein the invisible light source and invisible light sensor are located proximate to a roof of the vehicle.

15. A method of controlling a reading lamp on a vehicle, comprising:
illuminating within an illumination pattern that defines a region proximate to a passenger in a vehicle with invisible light;
sensing with an invisible light sensor an amplitude of the invisible light reflected from one or more objects in the region proximate to the passenger in the vehicle;
determining with a controller a presence of reading material having a substantial amount of light reflective material in the region by comparing the amplitude of the reflected invisible light to one or more predetermined values indicative of ready material; and
activating with the controller the reading lamp to automatically turn on the reading lamp when the amplitude exceeds a predetermined value without having to activate a switch to turn on the reading lamp.

16. The method of claim 15, wherein the invisible light source comprises an infrared light source.

17. The method of claim 15, wherein the invisible light source generates a pattern of invisible light in a cone-shaped pattern.

18. The method of claim 15 further comprising the step of sensing ambient light with a visible light photosensor, wherein the controller further controls the reading lamp based on the sensed ambient light.

19. The method of claim 15 further including the step of capturing with a camera sensor one or more images of the region proximate to the passenger in the vehicle, wherein the controller further controls the reading lamp to turn on the reading lamp based on the captured images containing the reading material.

20. The method of claim 15 further comprising the step of adjusting light intensity of the reading lamp based on the reflected invisible light.
